(19) United States
(12) Patent Application Publication
(10) Pub. No.: US 2025/0183631 A1
(43) Pub. Date: Jun. 5, 2025

(54) METHOD AND A TIGHT CONNECTOR, FOR FIXING A CABLE ESPECIALLY AN ELECTRICAL ONE

(71) Applicant: Stanislaw WOLOSZYN, Szczecin (PL)

(72) Inventor: Stanislaw WOLOSZYN, Szczecin (PL)

(21) Appl. No.: 18/837,557

(22) PCT Filed: Feb. 8, 2023
(86) PCT No.: PCT/PL2023/000009

§ 371 Date: Aug. 9, 2024

(30) Foreign Application Priority Data
Feb. 9, 2022 (PL) P.440336

(51) Int. Cl. H02G 1/06; H02G 15/013

(52) U.S. Cl. CPC H02G 1/06; H02G 15/013

(57) ABSTRACT

The object of the invention is a method and a connector for fixing a cable, especially an electrical one, in a wall of electronic, electrical, pneumatic, hydraulic and mechanical equipment. A method for attaching a cable, especially an electrical one, in a wall, characterised in that a profiled sleeve constituting a connector body (1) is seated in an opening in the wall (4), so that the abutment surface (2) of the body (1) abuts the wall (4), and subsequently, acting axially with a predetermined force F1, a part of the body (1) is deformed, forming an outer ring (7) on the connector body (1), in the vicinity of the housing wall (4), while a cable (6), especially an electrical one, is inserted into the through opening (3) of the connector body (1), followed by radial crimping of the part of the body (1) with the force F2. The method according to claim (1), characterised in that, before the operation of radial crimping/clamping, a flexible seal (8), in which the cable (6), especially an electrical one is placed, is inserted into the through opening (3) of the connector body (1). A connector for fixing/attaching cables, especially electrical ones, constituting a passage in a wall, characterised in that a profiled sleeve constituting the connector body (1) is seated in an opening in the wall (4) by means of a formed outer ring (7) and an abutment surface (2), in addition the connector body (1) comprising a through opening (3) in which a radially clamped in a part of the connector body (1) cable (6), especially an electrical one, is placed. The connector profiled body (1) has a thicker wall in the radially clamped part, than in the part deformed by axially applied forces.

The object of the invention is a method and a connector for fixing a cable, especially an electrical one, in a passage, in wall of electronic, electrical, pneumatic, hydraulic and mechanical equipment.

Contemporary connectors for cables such as cable glands consist of multiple parts, and they require precise and expensive machining, during production and sometimes during assembly. In addition, in order to ensure a good sealing level, thread-based assembly of a sealed connector requires a gasket between the surface through which a cable is led and the connector. This gasket is often subjected to high temperatures, increasing the risk of leakage, or completely eliminating the possibility to use the connector. The problem occurring in the abovementioned connectors is that the clamp of the connector gasket is implemented by screwing in a threaded cup, which causes displacement (rotation) of the gasket and the cable placed in the connector, which may lead to damaging the cable, or to leakage.

From the international patent application WO 2015/023814 there is a known solution of a watertight aperture with an added element which separates the gasket from the nut. A drawback of this solution is its low resistance to temperature, and the high production cost.

From the German patent application DE 102 31 309 there is a known solution of a fireproof housing with a through opening for a cable, in which the remaining free volume is filled with a pore-forming sealing material. At the same time, this solution protects a cable against being torn out.

The German patent description DE 10 61 861 presents a connector with an insert made of a flexible rubber material.

Known fixtures/connectors for attaching cables consist of clamps, usually two-part, which along with the attached cable are usually screwed up to the housing wall of a device by means of screws, which are screwed into either threaded openings, or into openings adjusted to self-tapping screws.

Contemporary connectors consist of multiple parts, and they require precise and expensive machining, during production and sometimes during assembly.

The purpose of the invention is to develop a simple technical solution related to a sealed aperture/connector seated in a wall, in which a cable is placed, especially an electrical one.

According to the invention, the method for attaching a cable, especially an electrical one, in a wall, characterised in that a profiled sleeve constituting a connector body is seated in an opening in the wall, so that the abutment surface of the body abuts the wall, and subsequently, acting axially with a predetermined force F1, a part of the body is deformed, forming an outer ring on the connector body, in the vicinity of the housing wall, while a cable, especially an electrical one, is inserted into the through opening of the connector body, followed by radial crimping of the part of the body with the force F₂.

Before the operation of radial crimping/clamping, a flexible seal, in which the cable, especially an electrical one is placed, is inserted into the through opening of the connector body.

A gasket abutting the abutment surface and the surface of the wall is placed before seating the connector body in the opening in the wall.

Upon seating the connector body in the opening in the wall, and before forming the ring, the gasket abutting the surface of the wall is placed.

According to the invention, the connector for fixing/attaching cables, especially electrical ones, constituting a passage in a wall, characterised in that a profiled sleeve constituting the connector body is seated in an opening in the wall by means of a formed outer ring and an abutment surface, in addition the connector body comprising a through opening in which a radially clamped in a part of the connector body cable, especially an electrical one, is placed.

The connector profiled body has a thicker wall in the radially clamped part, than in the part deformed by axially applied forces.

Inside the through opening there is an inner flange.

The abutment surface of the connector body results from the varying (is a result of the diverse) thickness of the walls of the body.

The connector body has an outer flange, which comprises the abutment surface.

The through opening has a flexible seal seated therein, inside which a cable is placed, especially an electrical one.

A gasket abutting the wall is situated between the connector body and the wall.

The abutment surface of the connector body is perpendicular to the surface of the body.

The abutment surface of the connector body is a conical surface.

The outer part of the connector body has the shape of two sleeves with different outer diameters, mutually connected by a conical element constituting the abutment surface.

The attachment of a cable according to the invention ensures tight sealing, even without a gasket between the surface of the wall and the body of the connector, and it ensures operation even in elevated temperatures.

Mounting of the connector body in the opening in the wall is performed by clamping with a predetermined force F₁, acting parallel to the axis of symmetry of the body. On the other hand, a cable, especially an electrical one, placed in the through opening of the body, is attached and sealed by clamping the end part of the body with a predetermined force F₂, acting radially. The connector body is made of materials susceptible to plastic deformations, e.g. aluminium or brass. The connectors are resistant to loosening, and they ensure sealing of the passage. The seal in which a cable is placed must be tightly fit with the through opening of the body, while the outer diameter of the seal should be larger by 0.5 to 3% than the diameter of the through opening. It is also possible to use a seal with a flange; in this case, the diameter of the seal may be smaller by 5% than the diameter of the through opening in the body. The connectors are characterised by simple construction and low production and assembly costs.

The connector according to the invention serves several functions; apart from sealing against liquids, dust and gases, it also provides protection against tearing out a cable, and it is also resistant to elevated temperatures.

The object of the invention is presented in the drawing, where

FIG. 1—presents the profiled connector body with a conical flange,

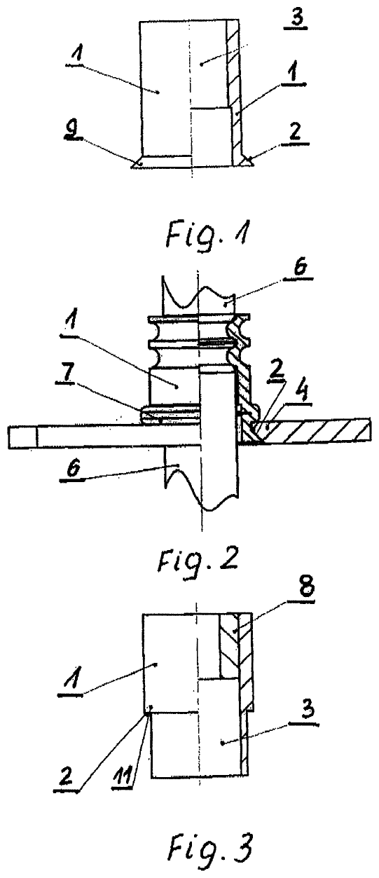

FIG. 2—presents the connector seated in an opening in the wall, with the body provided with the conical flange, upon clamping along the axis of symmetry, and with indentations formed as a result of radial clamping of one end of the body,

FIG. 3—presents the connector body comprising a step on the outer plane,

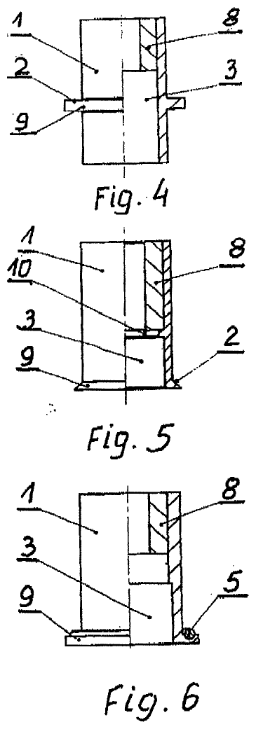

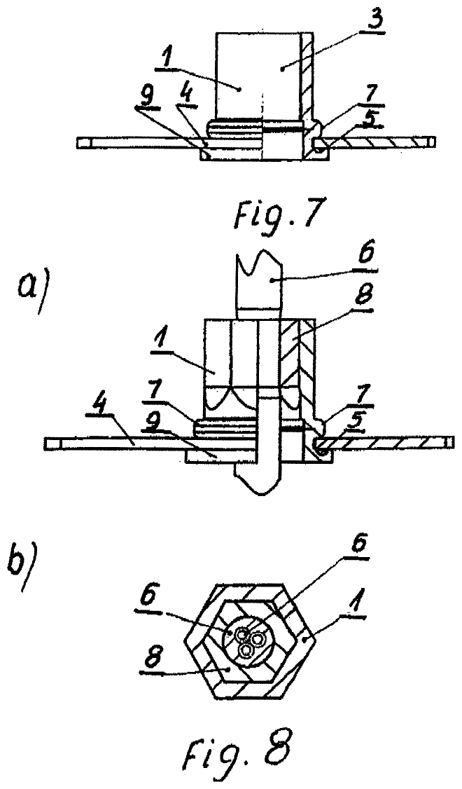

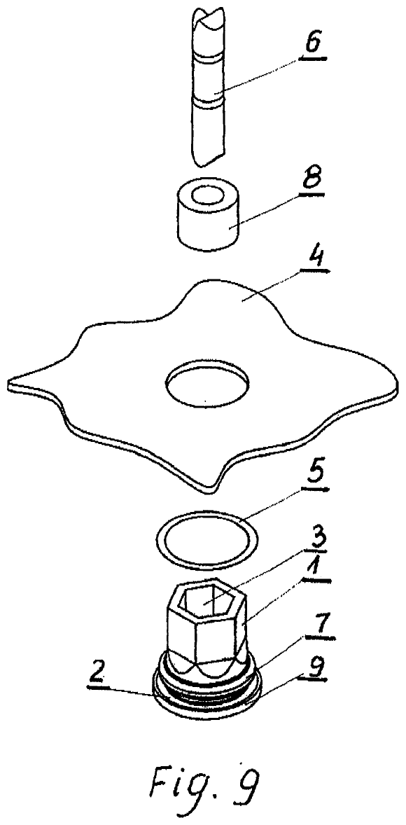

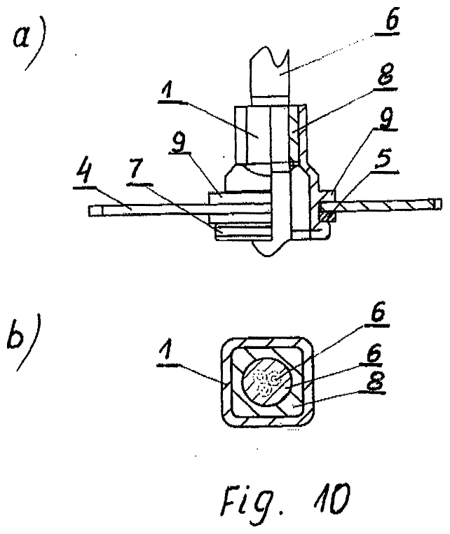

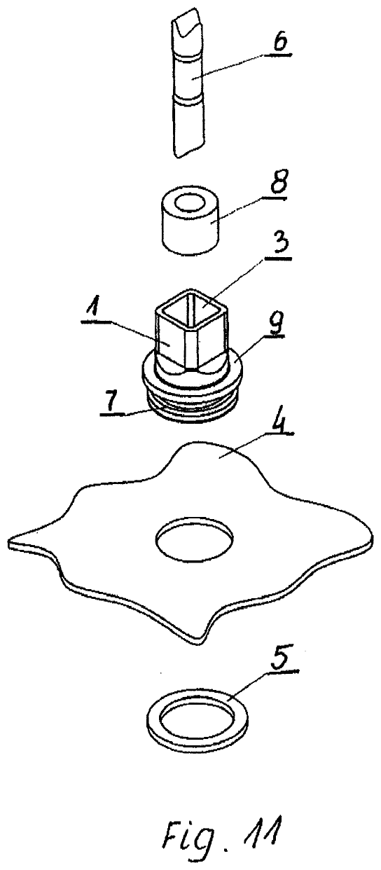

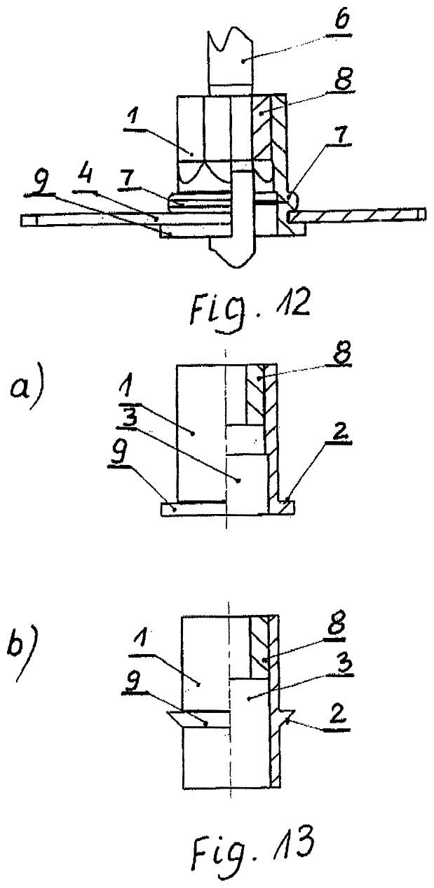

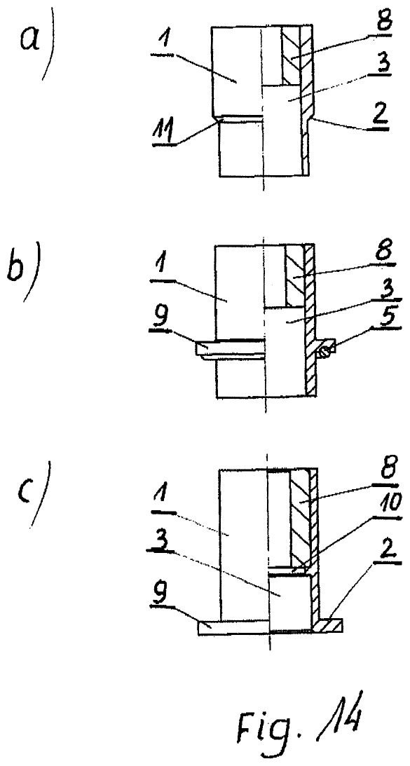

FIG. 4—presents the body with the flange at a certain distance from the end of the body,

FIG. 5—presents the body, with the conical flange on the outer plane and a flange inside the through opening,

FIG. 6—presents the body with the flange and a gasket on the end,

FIG. 7—presents the body, with the flange on the end, upon forming the outer ring on the body,

FIG. 8—presents the connector with the body on which the outer ring is formed, and upon clamping the remaining part of the body in the form of a rectangular prism with a hexagonal base,

FIG. 9—presents in an exploded view elements of the connector with the body upon clamping along the axis of symmetry, and upon radial clamping of one end of the body in the shape of a rectangular prism with a hexagonal base,

FIG. 10—presents the connector with the flange at a certain distance from the end of the body, upon longitudinal and radial clamping of the body, with a seal on a cable and the gasket between the plane of the wall and the outer ring, and the cross-section of the body in the radially clamped part is square shaped,

FIG. 11—presents in an exploded view the elements of the connector with the body and seals, upon clamping along the axis of symmetry and upon radial clamping of one end of the body in the shape of a rectangular prism with a square base,

FIG. 12—presents the connector with the outer flange on the body, with the formed outer ring and a part of the body formed as a rectangular prism with a hexagonal base,

FIG. 13—a)—presents the body with the flange and the seal for a cable, b)—presents the body with the conical flange and the seal for a cable,

FIG. 14—presents a)—the body with the seal and with a conical step on the outer plane, b)—the connector body with the outer flange and the seal for a cable and a gasket under the flange, c)—the body with the flange on one end, the seal for a cable, and an inner flange in the through opening, on which the seal for a cable is supported.

The connector for attaching especially an electrical cable in the housing wall 4 comprises a profiled cylindrical body 1 in the form of a sleeve with a through opening 3. The body 1 with a conical flange 9 is seated in an opening in the wall 4 where, upon clamping with a predetermined force F₁, acting parallel to the axis of symmetry of the body 1, an outer ring 7 is formed on the outer plane of the body 1. A step resulting from the difference in the thickness of the walls of the body 1 is visible in the body 1. A cable 6, radially clamped with a predetermined force F₂ in the end part of the body 1, is situated in the through opening 3 of the body 1. The radial clamping has formed indentations on the body 1

### (FIG. 1, FIG. 2).

In another embodiment, the outer plane of the body 1 comprises a step 11 which results from the difference in the thickness of the walls of the body 1. The body 1 is seated in the opening in the wall 4 by a part with a thinner wall, where, upon clamping with a predetermined force F₁, acting parallel to the axis of symmetry of the body 1, an outer ring 7 is formed on the outer plane of the body 1. Inside the through opening 3 there is a seal 8. (FIG. 3)

The next embodiment is a connector body 1 which comprises a flange 9 on its outer surface, at a certain distance from the end of the body, and a seal 8.

### (FIG. 4).

The next alternative is a connector body 1 comprising a conical flange 9. An inner flange 10 is situated in the through opening 3, and a seal 8 is seated thereon.

### (FIG. 5).

In another alternative, the connector body 1 has a profiled flange 9 on one end, with a gasket 5 seated thereon. A seal 8 is placed inside the through opening 3.

### (FIG. 6).

In the next alternative of the connector, a body 1 with a gasket 5, is presented seated in the opening in the wall 4, and with a ring 7 formed upon clamping with a predetermined force F₁, acting parallel to the axis of symmetry of the body 1.

### (FIG. 7).

The next version of the connector is characterised in that a body 1 with a flange 9 and a gasket 5 situated therein, is seated in the opening in the wall 4, where, upon clamping with a predetermined force F₁ acting parallel to the axis of symmetry of the body 1, an outer ring 7 is formed on the outer plane of the body 1. A seal 8, in which a cable 6 is seated, is placed in the through opening 3. On the other hand, upon radial clamping with a predetermined force F₂, in the end part of the body 1 the connector has a shape similar to a rectangular prism with a hexagonal base.

### (FIGS. 8, 9).

Another version of the connector has a shape similar to a rectangular prism with a square base upon clamping. (FIGS. 10, 11).

The connector body 1 may have a very diverse shape, which is exampled in the following drawings from FIG. 1 to FIG. 14.

1. A method for attaching a cable, especially an electrical one, in a wall, characterised in that a profiled sleeve constituting a connector body /1/ is seated in an opening in the wall /4/, so that the abutment surface /2/ of the body /1/ abuts the wall /4/, and subsequently, acting axially with a predetermined force F₁, a part of the body /1/ is deformed, forming an outer ring /7/ on the connector body /1/, in the vicinity of the housing wall /4/, while a cable /6/, especially an electrical one, is inserted into the through opening /3/ of the connector body /1/, followed by radial crimping of the part of the body /1/ with the force F₂.

2. The method according to claim 1, characterised in that, before the operation of radial crimping/clamping, a flexible seal /8/, in which the cable /6/, especially an electrical one is placed, is inserted into the through opening /3/ of the connector body /1/.

3. The method according to claim 1, characterised in that a gasket /5/ abutting the abutment surface /2/ and the surface of the wall /4/ is placed before seating the connector body /1/ in the opening in the wall /4/.

4. The method according to claim 1, characterised in that upon seating the connector body /1/ in the opening in the wall /4/, and before forming the ring /7/, the gasket /5/ abutting the surface of the wall /4/ is placed.

5. A connector for fixing/attaching cables, especially electrical ones, constituting a passage in a wall, characterised in that a profiled sleeve constituting the connector body /1/ is seated in an opening in the wall /4/ by means of a formed outer ring /7/ and an abutment surface /2/, in addition the connector body /1/ comprising a through opening /3/ in which a radially clamped in a part of the connector body /1/ cable /6/, especially an electrical one, is placed

6. The connector according to claim 5, characterised in that the connector profiled body /1/ has a thicker wall in the radially clamped part, than in the part deformed by axially applied forces.

7. The connector according to claim 5, characterised in that inside the through opening /3/ there is an inner flange /10/.

8. The connector according to claim 5, characterised in that the abutment surface /2/ of the connector body /1/ results from the varying (is a result of the diverse) thickness of the walls of the body /1/ which are referred to in claim 6.

9. The connector according to claim 5, characterised in that the connector body /1/ has an outer flange /9/, which comprises the abutment surface /2/.

10. The connector according to claim 5, characterised in that the through opening /3/ has a flexible seal /8/ seated therein, inside which a cable /6/ is placed, especially an electrical one.

11. The connector according to claim 5, characterised in that the gasket /5/ abutting the wall /4/ is situated between the connector body /1/ and the wall /4/.

12. The connector according to claim 5, characterised in that the abutment surface /2/ of the connector body /1/ is a conical surface.

13. The connector according to claim 5, characterised in that the abutment surface /2/ of the connector body /1/ is a surface perpendicular to the body /1/.
